(19) United States
(12) Patent Application Publication
(10) Pub. No.: US 2024/0045091 A1
(43) Pub. Date: Feb. 8, 2024

(54) SYSTEMS AND METHODS OF GENERATING HIGH RESOLUTION SEISMIC USING SUPER RESOLUTION INVERSION

(71) Applicant: ConocoPhillips Company, Houston, TX (US)

(72) Inventors: Chengbo Li, Houston, TX (US); Baishali Roy, Houston, TX (US); Charles C. Mosher, Houston, TX (US)

(21) Appl. No.: 18/230,815

(22) Filed: Aug. 7, 2023

Related U.S. Application Data
(60) Provisional application No. 63/395,474, filed on Aug. 5, 2022.

(51) Int. Cl. G01V 1/30

(52) U.S. Cl. CPC G01V 1/302; G01V 2210/632; G01V 2210/665

(57) ABSTRACT

Systems and methods for reservoir modeling include a super resolution seismic data conversion platform for converting input seismic data into high resolution output seismic data. The super resolution seismic data conversion platform can perform a super resolution inversion on the input seismic data by imposing sparsity and/or coherency assumptions on geophysical parameters represented by wavelet information of the input seismic data. For instance, a seismic trace interval can be determined, and both a reflection coefficient and an acoustic impedance of the seismic trace interval can be constrained. An optimization problem, using the constrained reflection coefficient and the constrained acoustic impedance, can be generated and/or solved by a sparse inversion. As such, a vertical resolution, as well as a seismic bandwidth, of super resolution output seismic data can be increased, improving subterranean feature (e.g., sand and/or shale characteristics) interpretation and well planning and construction.

### CROSS-REFERENCE TO RELATED APPLICATIONS

The present application claims priority to U.S. Provisional Patent Application No. 63/395,474 filed on Aug. 5, 2022, which is incorporated by reference in its entirety herein.

### FIELD

The presently disclosed technology relates to modeling reservoirs and more particularly to seismic inversion modeling.

### BACKGROUND

Seismic reservoir modeling is used to understand the physical characteristics of a subterranean feature by converting seismic data into a 2D or 3D image and building the corresponding reservoir model. A given reservoir can have many variables that cause variations in the seismic responses. Seismic reservoir modeling has the potential to provide unique insights for exploration and development, however, seismic resolution is often a key limiting factor for stratigraphic and structural interpretations. The band-limited nature of seismic data constrains the data interpretability, often resulting in ambiguities in thin reservoir characterization. Many factors contribute to the resolution ranging from seismic acquisition to processing and imaging. The ability to perform reservoir characterization is highly dependent on the quality and resolution of the seismic data.

It is with these observations in mind, among others, that various aspects of the present disclosure were conceived and developed.

### SUMMARY

Implementations described and claimed herein address the foregoing problems by providing a method for seismic reservoir modeling, which can generate high resolution output seismic data. The method can comprise: receiving a seismic trace interval of input seismic data representing a subterranean feature; determining a wavelet operator and an impedance/reflectivity model of the seismic trace interval; and generating high resolution output seismic data corresponding to the input seismic data by performing a super resolution inversion. Performing the super resolution inversion can include: imposing a first constraint on the reflection coefficients; imposing a second constraint on an acoustic impedance model; and performing a dual domain sparse inversion.

Furthermore, in some instances, performing the super resolution inversion includes: solving an optimization problem such that the acoustic impedance model equals a recursion of one plus the reflection coefficient over one minus the reflection coefficient, and/or solving the optimization problem such that a square of a difference between the seismic trace interval and a product of the wavelet operator and the reflection coefficient is less than an error misfit value. The method can further comprise presenting the high resolution output seismic data at a display of a computing device to visually represent an attribute section of the subterranean feature. Moreover, the method can further comprise identifying, using the high resolution output seismic data, a sand quality of a portion of the subterranean feature. In some scenarios the first constraint promotes sparsity of reflection coefficients while omitting a spatial relation among seismic traces and/or the second constraint is a total variation constraint with spatial relation taken into account.

In some instances, a method for seismic reservoir modeling comprises: determining a wavelet operator and a reflection coefficient of a seismic trace interval of input seismic data representing a subterranean feature; and generating high resolution output seismic data corresponding to the input seismic data by performing a super resolution inversion on the seismic trace interval. The super resolution inversion can include: constraining the reflection coefficient and an acoustic impedance model corresponding to the reflection coefficient; and solving an optimization problem such that the acoustic impedance coefficient equals a recursion of one plus the reflection coefficient over one minus the reflection coefficient.

In some examples, the method comprises performing a redatum for the input seismic data to a reference horizon or reference surface. Additionally, the input seismic data can be a time volume stacked image dataset. The method can comprise normalizing the wavelet operator to a maximum wavelet value prior to constraining the reflection coefficient. In some scenarios, normalizing the wavelet operator to the maximum wavelet value preserves an amplitude variation with offset (AVO) effect.

In some instances, a method for seismic reservoir modeling comprises: determining a wavelet operator and a reflection coefficient of a seismic trace interval of input seismic data representing a subterranean feature; and generating high resolution output seismic data corresponding to the input seismic data by performing a super resolution inversion on the seismic trace interval. The super resolution inversion can include: constraining the reflection coefficient and an acoustic impedance coefficient corresponding to the reflection coefficient; and solving an optimization problem such that a square of a difference between the seismic trace interval and a product of the wavelet operator and the reflection coefficient is less than an error misfit value.

In some instances, the super resolution output seismic data has an increased seismic bandwidth relative to the input seismic data. Additionally or alternatively, the super resolution output seismic data can have an increased vertical resolution relative to the input seismic data. For instance, the input seismic data can have a vertical resolution of 15 meters and the super resolution output seismic data can have the increased vertical resolution of 10 meters or finer. In some scenarios, the method further comprises presenting the high resolution output seismic data at a display of a computing device to visually represent a stratigraphic variation of stack sand of the subterranean feature. Moreover, the method can further comprise determining a horizontal section location of a horizontal well for construction based on the super resolution output seismic data.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

In order to describe the manner in which advantages and features of the presently disclosed technology can be obtained, a more particular description of the principles briefly described above will be rendered by reference to specific example implementations thereof which are illustrated in the appended drawings. Understanding that these drawings depict only exemplary implementations of the presently disclosed technology and are not therefore to be considered to be limiting of its scope, the principles herein are described and explained with additional specificity and detail through the use of the accompanying drawings in which:

FIG. 1 illustrates an example network environment that may implement various systems and methods discussed herein;

FIGS. 2A and 2B depict a block diagrams illustrating a system including an example super resolution seismic data conversion platform, which can form at least a portion of the network environment of FIG. 1;

FIG. 3 illustrates example attribute sections generated by a super resolution seismic data conversion platform, which can form at least a portion of the network environment of FIG. 1;

FIG. 4 illustrates an example one or more computing system(s) for implementing the super resolution seismic data conversion platform, which can form at least a portion of the network environment of FIG. 1;

FIG. 5 illustrates an example method for generating super resolution output seismic data, which can be performed by least a portion of the network environment of FIG. 1; and

FIG. 6 illustrates an example method for generating super resolution output seismic data, which can be performed by at least a portion of the network environment of FIG. 1.

### DETAILED DESCRIPTION

The presently disclosed technology involves systems and methods for performing a post-imaging inversion that converts input seismic data into super resolution output seismic data with a broadened seismic bandwidth. By imposing sparsity and/or coherency assumptions on geophysical parameters modeled by the input seismic data, a constrained minimization problem is formulated to invert high-resolution seismic from its low-resolution counterpart. This super resolution conversion method can use seismic data only to drive the inversion, for instance, by omitting well data which avoids introducing bias from well data. The inverted super resolution data can increase an interpretation capability of the reservoir model, thus revealing sand connectivity and stacking patterns at the reservoir level which were not observable in the original seismic data (e.g., the lower resolution seismic data input). Well data can be incorporated into the super seismic resolution data and/or be used as training data for examining the super resolution output seismic data against well data. In some examples, the increased resolution of the super resolution output seismic is useful for stratigraphic interpretation and well planning. For instance, improved horizontal well section placement and construction (e.g., based on better interpretation of sand quality features and/or shale features) can be performed as part of the systems and methods disclosed herein.

It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

### I. Terminology

A seismic reservoir model is a simulated model that can be used as a realistic and highly utilized reservoir management tool. The seismic reservoir model can also be used as a proxy model for reservoir simulation. Additionally, the seismic reservoir model can be used to forecast production, operations, efficiency, and other statistics for reservoirs.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Further, any one of the features in the present description may be used separately or in combination with any other feature. For example, references to the term “implementation” means that the feature or features being referred to are included in at least one aspect of the present description. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations, but is not necessarily included. Thus, the present description may include a variety of combinations and/or integrations of the implementations described herein. Additionally, all aspects of the presently disclosed technology as described herein are not essential for its practice.

### II. General Architecture and Operations

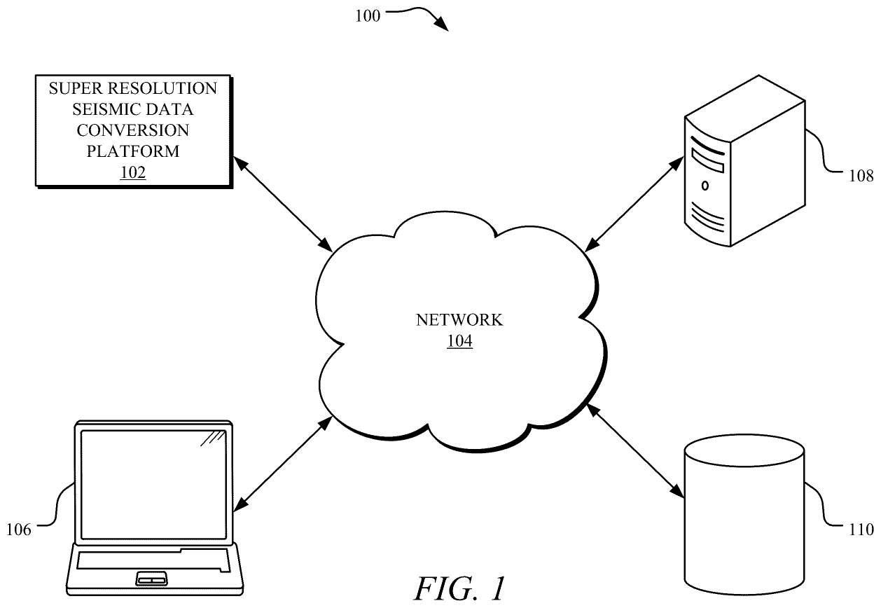

To begin a detailed discussion of an example system for super resolution inversion, reference is made to FIG. 1. FIG. 1 illustrates an example network environment 100 for implementing the various systems and methods, as described herein including a super resolution seismic data conversion platform 102. A network 104 can be used by one or more computing or data storage devices for implementing the super resolution seismic data conversion platform 102. The super resolution seismic data conversion platform 102 may be a remote service, software as a service (SaaS) and/or cloud service for collecting and aggregating seismic data from multiple sources. The super resolution seismic data conversion platform 102 can include software modules for converting seismic data into super resolution seismic data, as discussed in greater detail below. For instance, any of the software operations (e.g., the computing system 400, etc.) discussed herein can be incorporated into the super resolution seismic data conversion platform 102 (e.g., as executable python script) to scale-up the software components and make them accessible to a variety of users in a multiple locations using many different types of computing devices.

In some implementations, various components of the super resolution seismic data conversion platform 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system including the super resolution seismic data conversion platform 102. In one implementation, the server 108 also hosts a website or an application that users may visit to access the network environment 100, including the super resolution seismic data conversion platform 102. The server 108 may be one single server, a plurality of servers with each such server being a physical server or a virtual machine, or a collection of both physical servers and virtual machines. In another implementation, a cloud hosts one or more components of the system. The super resolution seismic data conversion platform 102, the user devices 106, the server 108, and other resources connected to the network 104 may access one or more additional servers for access to one or more websites, applications, web services interfaces, etc. that are used for generating the super resolution seismic data and/or incorporating the super resolution seismic data into well section placement and construction.

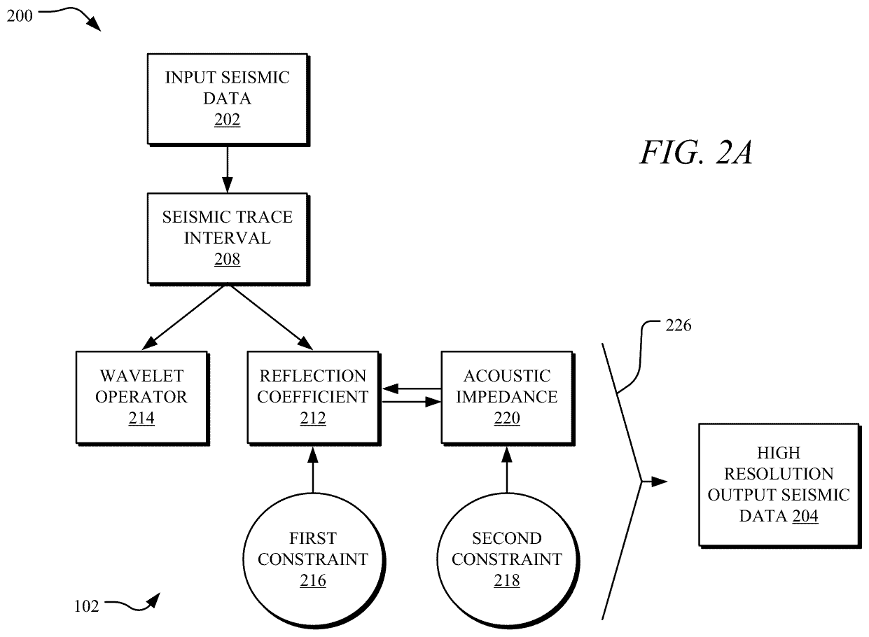

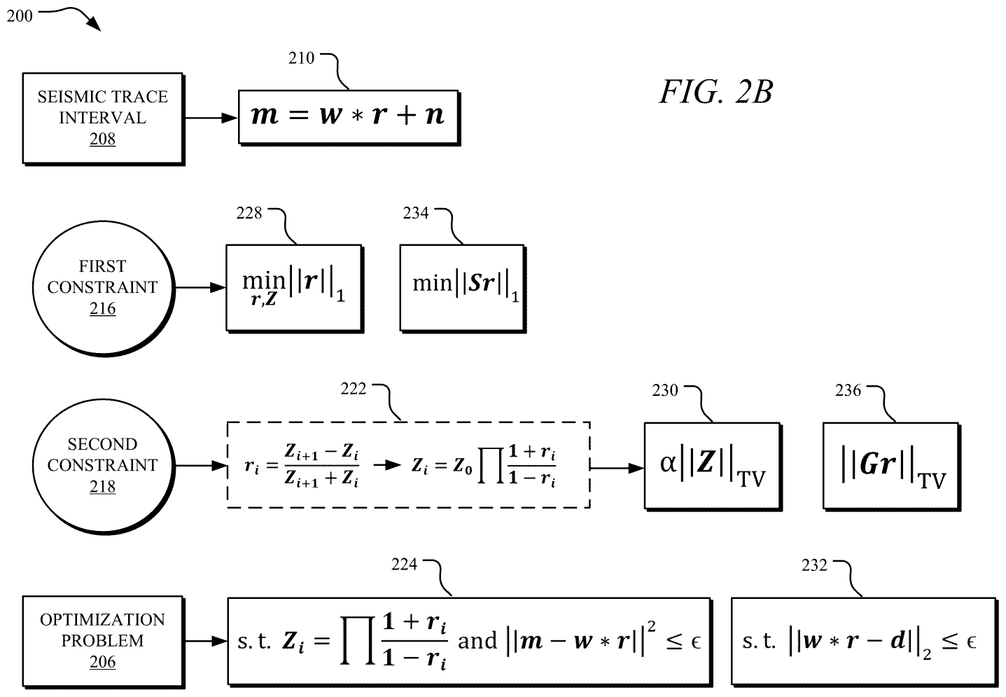

Turning to FIGS. 2A and 2B, a block diagram of a system 200 including the super resolution seismic data conversion platform 102 is depicted. The super resolution seismic data conversion platform 102 can perform operations to convert input seismic data 202 into high resolution output seismic data 204, for instance, by simultaneously regularizing a reflectivity model and relative impedance model. Furthermore, an optimization problem 206 is formulated and solved using a mix of L1 and total variation (TV) terms constrained by input seismic data, as discussed in greater detail below. The system 200 depicted in FIGS. 2A and 2B can form at least a part of the network environment 100 or system depicted in FIG. 1.

In some examples, the input seismic data 202, which can be received by the super resolution seismic data conversion platform 102, includes a time volume dataset of seismic information collected at a target location. The target location can include a subterranean feature, such as a subterranean reservoir being surveyed and/or modeled. A seismic trace interval 208 can be identified (e.g., selected and/or extracted) from the input seismic data 202. The seismic trace interval 208 can be a subset of the input seismic data 202 representing a particular time interval, a particular spatial location of the target location (e.g., a vertical slice and/or a horizontal slice), and can include one or more wavelet traces of the input seismic data 202. Depending on the data characteristics, a stationary or a time/space-varying wavelet extraction technique can be performed. In some instances, to improve compliance with the regularizations, the seismic trace interval 208 and/or the input seismic data 202 can be redatumed to a reference horizon or reference surface. This redatuming step can reduce the overall steep dipping events without affecting the pertinent information of the wavelet represented by the seismic trace interval 208. In some instances, following a upper resolution and/or sparse inversion procedure (discussed below), the redatum can be reverted back to an original form. Moreover, the wavelet represented by the seismic trace interval 208 can be normalized to its maximum in order to preserve amplitudes and/or amplitude variation with offset (AVO) effects.

In some instances, the seismic trace interval 208 can include a partial or full image stack (m) to which a convolutional model can be employed. The wavelet of the seismic trace interval 208 can be assumed to be stationary within the given interval, and the seismic data for the wavelet can be represented by a wavelet equation 210:

m=w*r+n,

where r denotes a reflection coefficient 212, w denotes a wavelet operator 214, and n is a noise term. For instance, a first constraint 216 can be an L1 constraint placed on reflection coefficient 212 that promotes the sparsity for the reflection coefficient 212 and/or assumes no spatial relation among traces. Furthermore a second constraint 218 can be put on an acoustic impedance 220. The acoustic impedance 220 can be derived and/or related to the reflection coefficient 212 using an impedance equation 222:

$${r}_{i} = \frac{{Z}_{i + 1} - {Z}_{i}}{{Z}_{i + 1} + {Z}_{i}} ,$$

where Zᵢ represents the acoustic impedance 220 at the i layer. Subsequently, using recursion gives the impedance equation 222:

$${Z}_{i} = {Z}_{0} \prod \frac{1 + {r}_{i}}{1 - {r}_{i}} .$$

By setting Z₀=1, a one-to-one mapping between reflection coefficients and (e.g. relative) acoustic impedance is determined.

The inversion problem may be under-determined in a least squares sense. As such, the band-limited nature of seismic data can be complemented by imposing regularizations on both the reflection coefficient 212 and the impedance the acoustic impedance 220. For instance, a first optimization problem 224 to be solved via a super resolution inversion 226, which can be:

$${min}_{r , Z} {‖ r ‖}_{1} + α {‖ Z ‖}_{TV} \\ s . t . {Z}_{i} = \prod \frac{1 + {r}_{i}}{1 - {r}_{i}} and {‖ m - w * r ‖}^{2} \leq ϵ ,$$

where α is a tradeoff parameter and ∈ is an error misfit. This first optimization problem 224 includes a first constrained reflectivity 228 of

$${min}_{r , Z} \vert \vert r {\vert \vert}_{1} ,$$

which can be added to a first constrained acoustic impedance 230 of α∥Z∥_{TV}. The first constrained reflection 228 can be an L1 constraint which promotes the sparsity of the reflection coefficient 212 but omits any spatial relation among traces. The extra TV constraint on the acoustic impedance 220 can encourage large leaps and can favor the layered structure, regularizing the data in both a temporal dimension and a spatial dimension. In some instances, to solve the optimization problem 206, a variant of an alternating direction method can be implemented as an optimizer.

In some examples, additionally or alternatively to the first optimization problem 224 discussed above, the optimization problem 206 can be framed differently as a second optimization problem 232 to be solved via the super resolution inversion 226, the second optimization problem 232 being:

min∥Sr∥₁+∥Gr∥_{TV}

s.t.∥w*r−d∥₂≤σ

such that the L1 constraint creates a second constrained reflectivity 234 of min∥Sr∥₁, which can be added to a second constrained acoustic impedance 236 of ∥Gr∥_{TV}, such that s.t.∥w*r−d∥₂≤σ, can be the constraint on the overall seismic.

It is to be understood that the process described above can be repeated iteratively for a plurality of seismic trace intervals 208 of the input seismic data 202 (e.g., at different horizontal locations, at different vertical locations, at different time dimensions, and the like) to generate a plurality of super resolution 2D images and/or a fully stacked super resolution 3D image from the input seismic data 202. The process(s) depicted in FIGS. 2A and 2B can also generate the high resolution output seismic data 204 without using well data and/or only using well data after the super resolution conversion, such that introducing bias at this earlier stage is avoided. Further inversion with well data can be proceeded once the high resolution output seismic data 204 is attained using the techniques discussed herein. These systems and methods can be more robust and resilient to ambient noise than other bandwidth extension techniques.

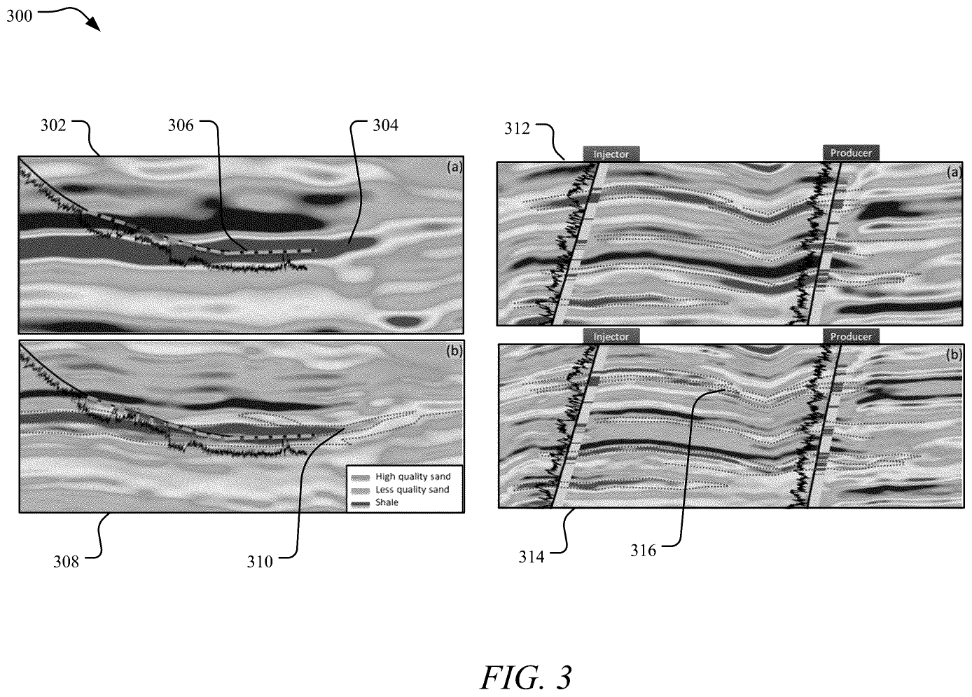

Turning to FIG. 3, an example system 300 including the super resolution seismic data conversion platform 102 is depicted. FIG. 3 depicts attribute sections generated using the techniques discussed herein. The system 300 can form at least a part of the system depicted in the network environment 100 of FIG. 1.

In some examples, a first attribute section 302 can be generated using the input seismic data 202 without performing the super resolution inversion 226. The first attribute section 302 can be an attribute section through a horizontal well and can represent one or more subterranean features, for instance, as different colors based on the calculated reflectivity and impedance values. The subterranean feature(s) 304 can include a sand feature, multiple different sand features having different sand qualities (e.g., high quality sand, less quality sand, etc.) a shale feature, a rock feature, combinations thereof, and the like. In some instances, the subterranean feature(s) 304 can be identified based on identifying a locally homogeneous structure. The subterranean feature(s) 304 can be identified via human interpretation or, in some cases, via machine-learning based interpretation (e.g., using any machine learning techniques, such as deep learning, supervised learning, unsupervised learning, regressions, neural networks, decision trees, gradient boosting, and the like). The first attribute section 302 can be presented at a display of a computing device, as discussed in greater detail below. Moreover, a well section 306 (e.g., a horizontal well section) can be presented layered onto the first attribute section 302, showing a location of the well section 306 relative to the subterranean feature(s) 304. Additionally or alternatively, the well section 306 layered onto the first attribute section 302 can be a prospective well section being considered for construction. An interpretation of the first attribute section 302 may suggest that the well drilled into high quality sand first at a deviated section, and then encountered less quality sand at the horizontal section. However, the sand quality variation may be indistinguishable in the first attribute section 302 due to insufficient resolution.

In some instances, a second attribute section 308 can be the high resolution output seismic data 204 generated with the super resolution seismic data conversion platform 102. For instance, the input seismic data 202 used to generate the first attribute section 302 can undergo the techniques discussed herein (e.g., the super resolution inversion 226 with the first constraint 216 on the wavelet operator 214 and the second constraint 218 on the acoustic impedance 220) to generate the second attribute section 308. The subterranean feature(s) 304 depicted in the first attribute section 302 can also be shown in the second attribute section 308. However, the second attribute section 308 can have a higher resolution than the first attribute section 302, such that a higher number of subterranean feature(s) 304 are identifiable and/or the subterranean feature(s) 304 is identifiable at a higher level of granularity and with more detail. For instance a shale or sand feature 310 that appears as a single homogenous feature in the first attribute section 302 can be identified as non-homogeneous or varying quality in the second attribute section 308 due to the higher resolution. An interpretation of the shale or sand feature 310 as a single feature based on the first attribute section 302 can be revised, based on the high resolution output seismic data 204 of the second attribute section 308, to recognize that the shale or sand feature 310 actually includes multiple sub-features with varying reflectivities and impedances. This observable amplitude variation provides for an interpretation that is able to separate upper sand from lower sand. As such, a location for constructing the well section 306 can be determined with improved reliability for accessing the high quality sand (e.g., the upper sand shelf or the lower sand shelf). In some instances, the well section 306 is constructed in response to the interpretation of the subterranean feature (e.g., the shale or sand feature 310) based on the second attribute section 308.

In some examples, a third attribute section 312 can be generated showing a section of an injector and producer pair. The third attribute section 312 can represent the input seismic data 202 without undergoing the techniques for generating the high resolution output seismic data 204. As such, various subterranean feature(s) are depicted at a first level of granularity/resolution. A fourth attribute section 314 can be generated using the same input seismic data 202 used to generate the third attribute section 312, but having undergone the techniques discussed herein. As such the fourth attribute section 314 can be the high resolution output seismic data 204, and can show the subterranean features (e.g., the shale or sand feature 310) with much higher resolution. In some examples, the attribute sections generated using the super resolution seismic data conversion platform 102 (e.g., the super resolution inversion 226 with the first constraint 216 on the wavelet operator 214 and the second constraint 218 on the acoustic impedance 220) can have an increased seismic bandwidth relative to those generated with only the input seismic data 202 (e.g., the first attribute section 302 and the third attribute section 312). Moreover, the second attribute section 308 and the fourth attribute section 314, generated with the high resolution output seismic data 204, can have an increased vertical resolution relative to those generated without undergoing the super resolution techniques discussed herein (e.g., the first attribute section 302 and the third attribute section 312). For instance, generating the attribute section with the super resolution seismic data conversion platform 102 to have the high resolution output seismic data 204 can increase the vertical resolution from 15 m to 10 m (e.g., a 30% increase). Accordingly, the increased resolution can lead to a more detailed interpretation of sand bodies 316 (e.g., depicted as outlined with dotted lines), such that lateral disconnects between sand bodies that were previously indiscernible can be identified. As such, the techniques discussed herein can improve injection well planning, production well planning, well section placement and construction, and the like.

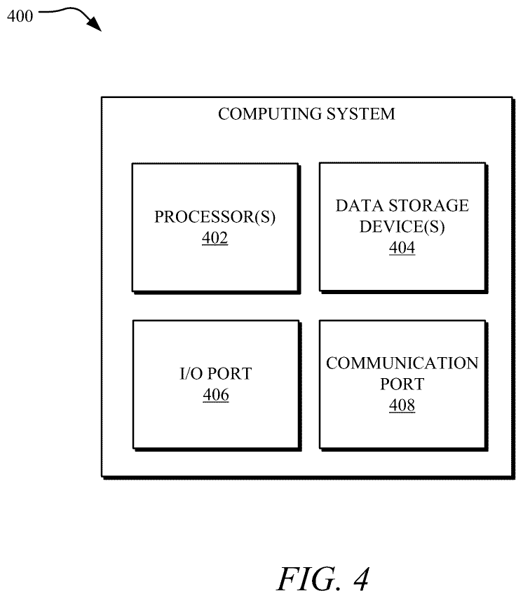

FIG. 4 shows an example of a computing system 400 having one or more computing units that may implement various systems and methods discussed herein is provided. The computing system 400 may be used to implement the super resolution seismic data conversion platform 102 as one or more software components, and can form a part of the network environment 100, and other computing or network devices. In some instances, the computing system 400 may be similar or identical to the user device 106, the server 108, the one or more databases 110, combinations thereof and the like. It will be appreciated that specific implementations of these devices may be of differing possible specific computing architectures not all of which are specifically discussed herein but will be understood by those of ordinary skill in the art.

The computing system 400 may be capable of executing a computer program product and/or a computer process. Data and program files may be input to the computing system 400, which reads the files and executes the programs therein. For instance, the computing system 400 can store the super resolution seismic data conversion platform 102 as one or more applications that receive various inputs (e.g., the input seismic data 202) and execute multiple algorithmic steps (e.g., as discussed herein regarding FIGS. 1-3, 5, and 6), to generate the high resolution output seismic data 204.

Some of the elements of the computing system 400 are shown in FIG. 4, including one or more hardware processors 402, one or more data storage devices 404, such as memory devices, and/or one or more ports 406 or 408. Additionally, other elements that will be recognized by those skilled in the art may be included in the computing system 400 but are not explicitly depicted in FIG. 4 or discussed further herein. Various elements of the computing system 400 may communicate with one another by way of one or more communication buses, point-to-point communication paths, or other communication means not explicitly depicted in FIG. 4.

The processor 402 may include, for example, a central processing unit (CPU), a microprocessor, a microcontroller, a digital signal processor (DSP), and/or one or more internal levels of cache. There may be one or more processors 402, such that the processor 402 comprises a single central-processing unit, or a plurality of processing units capable of executing instructions and performing operations in parallel with each other, commonly referred to as a parallel processing environment.

The computing system 400 may be standalone computer, a distributed computer, or any other type of computer, such as one or more external computers made available via a cloud computing architecture. The presently described technology is optionally implemented in software stored on the data stored device(s) 404, (e.g., memory device(s)), and/or communicated via one or more of the ports 406 or 408, thereby transforming the computing system 400 in FIG. 4 to a special purpose machine for implementing the operations described herein. Examples of the computing system 400 include personal computers, terminals, workstations, mobile phones, tablets, laptops, personal computers, multimedia consoles, gaming consoles, set top boxes, and the like.

The one or more data storage devices 404 may include any non-volatile data storage device capable of storing data generated or employed within the computing system 400, such as computer executable instructions for performing a computer process, which may include instructions of both application programs and an operating system (OS) that manages the various components of the computing system 400. The data storage devices 404 may include, without limitation, magnetic disk drives, optical disk drives, solid state drives (SSDs), flash drives, and the like. The data storage devices 404 may include one or more memory devices such as removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices can include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 404, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computing system 400 includes one or more ports, such as an input/output (I/O) port 406 and a communication port 408, for communicating with other computing, network, or reservoir development devices. It will be appreciated that the ports 406 and 408 may be combined or separate and that more or fewer ports may be included in the computing system 400.

The I/O port 406 may be connected to an I/O device, or other device, by which information is input to or output from the computing system 400. Such I/O devices may include, without limitation, one or more input devices, output devices, and/or environment transducer devices.

In some implementations, the input devices convert a human-generated signal, such as, human voice, physical movement, physical touch or pressure, and/or the like, into electrical signals as input data into the computing system 400 via the I/O port 406. Similarly, the output devices may convert electrical signals received from computing system 400 via the I/O port 406 into signals that may be sensed as output by a human, such as sound, light, and/or touch. The input device may be an alphanumeric input device, including alphanumeric and other keys for communicating information and/or command selections to the processor 402 via the I/O port 406. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen. Furthermore, the input devices and/or output devices can include a user interface (UI), for instance, to present the high resolution output seismic data 204 and/or various attribute sections (e.g., the first attribute section 302, the second attribute section 308, the third attribute section 312, the fourth attribute section 314, and the like).

In some implementations, a communication port 408 is connected to a network (e.g., the network 104) by way of which the computing system 400 may receive network data useful in executing the methods and systems set out herein as well as transmitting information and network configuration changes determined thereby. Stated differently, the communication port 408 connects the computing system 400 to one or more communication interface devices configured to transmit and/or receive information between the computing system 400 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 408 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 408 may communicate with an antenna or other link for electromagnetic signal transmission and/or reception.

The computing system 400 set forth in FIG. 4 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device. These sets of instructions can convert the computing system 400 into a special purpose device for generating the high resolution output seismic data 204 (e.g., a new type of file). As such, the computing system 400 can integrate the super resolution seismic data conversion platform 102 into a practical application by providing improved visualization (e.g., at a higher resolution) of attribute sections of the subterranean feature (e.g., the shale or sand feature 310), thus improving the technological field of reservoir modeling for the oil/gas industry. For instance, the implementation of the super resolution seismic data conversion platform 102 on the computing system 400 can improve the identification of locally homogenous features and locations of such features, such that well construction placement is improved.

In some instances, the super resolution seismic data conversion platform 102 may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The instructions, media for conveying such instructions, computing resources for executing them, and other structures for supporting such computing resources can be means for providing the functions described in these disclosures.

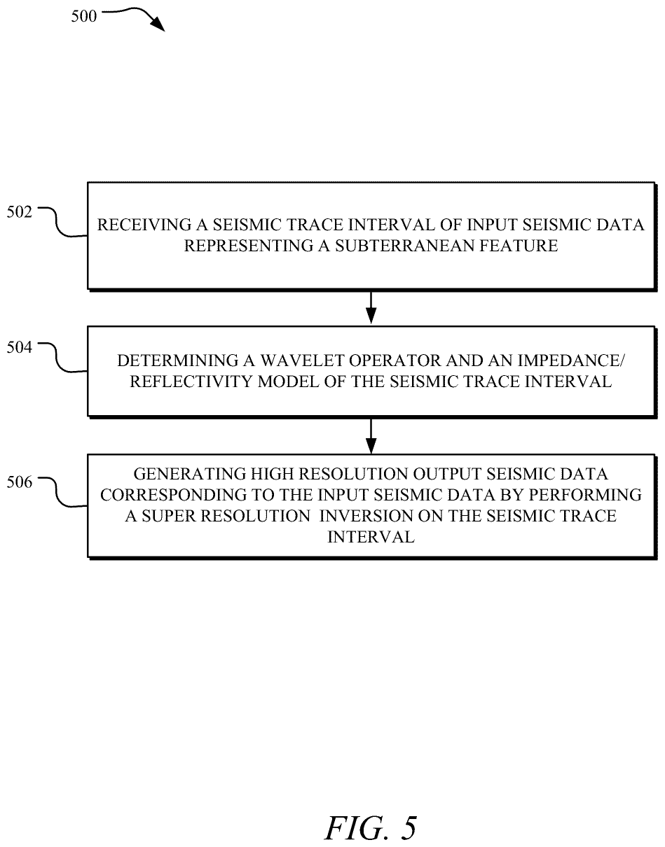

Turning to FIG. 5, an example method 500 for generating the high resolution output seismic data 204 with the super resolution seismic data conversion platform 102. The method 500 depicted in FIG. 5 can be performed by at least the systems depicted in FIGS. 1-4.

In some examples, at operation 502, the method 500 receives a seismic trace interval of input seismic data representing a subterranean feature. At operation 504, the method 500 can determine a wavelet operator and an impedance/reflectivity model of the seismic trace interval. At operation 506 the method 500 can generate high resolution output seismic data corresponding to the input seismic data by performing a super resolution inversion on the seismic trace interval.

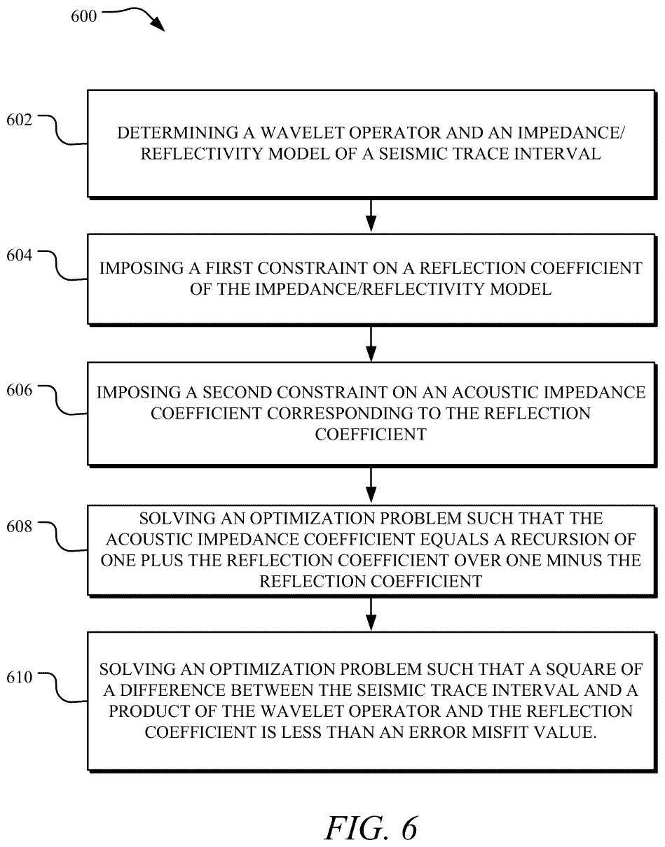

Turning to FIG. 6, an example method 600 for generating the high resolution output seismic data 204 with the super resolution seismic data conversion platform 102. The method 600 depicted in FIG. 6 can be performed by at least the systems depicted in FIGS. 1-4.

In some examples, at operation 602, the method 600 determines a wavelet operator. At operation 604, the method 70 can impose a first constraint on the reflection coefficient. At operation 606, the method can impose a second constraint on an acoustic impedance coefficient corresponding to the reflection coefficient. At operation 608, the method 600 can solve an optimization problem such that the acoustic impedance coefficient equals a recursion of one plus the reflection coefficient over one minus the reflection coefficient. At operation 610, the method 600 can solve an optimization problem such that a square of a difference between the seismic trace interval and a product of the wavelet operator and the reflection coefficient is less than an error misfit value.

It is to be understood that the specific arrangement, order, or hierarchy of steps or operations in the systems and methods depicted in FIGS. 5 and 6 and throughout this disclosure are instances of example approaches and can be rearranged while remaining within the disclosed subject matter. For instance, any of the steps depicted in FIGS. 5 and 6 and throughout this disclosure may be omitted, repeated, performed in parallel, performed in a different order, and/or combined with any other of the steps depicted in FIGS. 5 and 6 and throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for seismic reservoir modeling, the method comprising:
receiving a seismic trace interval of input seismic data representing a subterranean feature;
determining a wavelet operator and an impedance and reflectivity model of the seismic trace interval; and
generating high resolution output seismic data corresponding to the input seismic data by performing a super resolution inversion on the seismic trace interval, performing the super resolution inversion including:
imposing a first constraint on reflection coefficients of the impedance and reflectivity model; and
imposing a second constraint on an acoustic impedance model corresponding to the reflection coefficients.

2. The method of claim 1, wherein performing the super resolution inversion includes:
solving an optimization problem such that the acoustic impedance model equals a recursion of one plus a reflection coefficient of the impedance and reflectivity model over one minus the reflection coefficient.

3. The method of claim 2, wherein performing the super resolution inversion includes:
solving the optimization problem such that a square of a difference between the seismic trace interval and a product of the wavelet operator and the reflection coefficient is less than an error misfit value.

4. The method of claim 1, further comprising presenting the high resolution output seismic data at a display of a computing device to visually represent an attribute section of the subterranean feature.

5. The method of claim 1, wherein performing the super resolution inversion further comprises imposing a third constraint or regularization on a data misfit.

6. The method of claim 1, further comprising identifying, using the high resolution output seismic data, a sand quality of a portion of the subterranean feature.

7. The method of claim 1, wherein the first constraint promotes sparsity of reflection coefficients while omitting a spatial relation among seismic traces.

8. The method of claim 1, wherein the second constraint is a total variation constraint.

9. The method of claim 8, wherein the second constraint regularizes the input seismic data in a temporal dimension and a spatial dimension.

10. A method for seismic reservoir modeling, the method comprising:
determining a wavelet operator and an impedance and reflectivity model of a seismic trace interval of input seismic data representing a subterranean feature; and
generating high resolution output seismic data corresponding to the input seismic data by performing a super resolution inversion on the seismic trace interval, the super resolution inversion including:
constraining a reflection coefficient of the impedance and reflectivity model;
constraining an acoustic impedance coefficient corresponding to the reflection coefficient; and
solving an optimization problem such that the acoustic impedance coefficient equals a recursion of one plus the reflection coefficient over one minus the reflection coefficient.

11. The method of claim 10, further comprising performing a redatum for the input seismic data to a reference horizon or reference surface.

12. The method of claim 10, wherein the input seismic data is a time volume stacked image dataset.

13. The method of claim 10, further comprising normalizing the wavelet operator to a maximum wavelet value prior to constraining the reflection coefficient.

14. The method of claim 13, wherein normalizing the wavelet operator to the maximum wavelet value preserves an amplitude variation with offset (AVO) effect.

15. A method for seismic reservoir modeling, the method comprising:
determining a wavelet operator and of a seismic trace interval of input seismic data representing a subterranean feature; and
generating high resolution output seismic data corresponding to the input seismic data by performing a super resolution inversion on the seismic trace interval, the super resolution inversion including:
constraining a reflection coefficient based of the seismic trace interval and an acoustic impedance coefficient corresponding to the reflection coefficient; and
solving an optimization problem such that a square of a difference between the seismic trace interval and a product of the wavelet operator and the reflection coefficient is less than an error misfit value.

16. The method of claim 15, wherein the high resolution output seismic data has an increased seismic bandwidth relative to the input seismic data.

17. The method of claim 15, wherein the high resolution output seismic data has an increased vertical resolution relative to the input seismic data.

18. The method of claim 17, wherein performing the super resolution inversion includes performing a dual domain sparse inversion.

19. The method of claim 15, further comprising presenting the high resolution output seismic data at a display of a computing device to visually represent a stratigraphic variation of stack sand of the subterranean feature.

20. The method of claim 15, further comprising determining a vertical section or a horizontal section location of a vertical well or a horizontal well for construction based on the high resolution output seismic data.
